(19) United States
(12) Patent Application Publication
(10) Pub. No.: US 2023/0148495 A1
(43) Pub. Date: May 18, 2023

(54) Keratin-Based Substrate and Methods of Forming the Same

(71) Applicants: Nanyang Technological University, Singapore (SG); President and Fellows of Harvard College, Cambridge, MA (US)

(72) Inventors: Kee Woei NG, Singapore (SG); Zhitong ZHAO, Singapore (SG); Xiao HU, Singapore (SG); Philip DEMOKRITOU, Cambridge, MA (US); Jason Christopher WHITE, Cambridge, MA (US)

(21) Appl. No.: 17/917,427

(22) PCT Filed: Apr. 28, 2021
(86) PCT No.: PCT/SG2021/050235

§ 371 Date: Oct. 6, 2022

Related U.S. Application Data
(60) Provisional application No. 63/016,299, filed on Apr. 28, 2020.

(51) Int. Cl. A01G 24/20; A01G 31/00; C05G 5/40; C05G 1/00; C05G 3/60; C05F 1/00; C05D 9/02

(52) U.S. Cl. CPC A01G 24/20; A01G 31/00; C05G 5/40; C05G 1/00; C05G 3/60; C05F 1/005; C05F 1/002; C05D 9/02

(57) ABSTRACT

The present disclosure refers to a keratin-based substrate, comprising a keratin derivative and natural biopolymer, where the keratin derivative and natural biopolymer are crosslinked. The present disclosure also refers to a method of forming a keratin-based substrate, comprising (i) mixing a solution of keratin derivative with a solution of natural biopolymer; and (ii) drying the resulting solution of step (i) to obtain the keratin-based substrate. The present disclosure further relates to the use of the substrate as a plant growth medium or hydroponic support medium. In a preferred embodiment, a substrate comprising keratin intermediate filament protein and cellulose nanofibers is provided.

### CROSS-REFERENCE TO RELATED APPLICATION

This application claims the benefit of priority of U.S. Provisional Application No. 63/016,299 filed on 28 Apr. 2020, the contents of it being hereby incorporated by reference in its entirety for all purposes.

### TECHNICAL FIELD

The present disclosure refers to a keratin-based substrate. The keratin-based substrate is useful for supporting seed germination and plant growth. The present disclosure also refers to methods of forming said substrates.

### BACKGROUND ART

As predicted, the world's population will increase to 9 billion by the year 2050 and global food crises will affect half the human population. Industrialization, environmental pollution and urbanization will continue to worsen the situation further by depleting fertile land. In order to address this global challenge of food and land shortage, hydroponics technology, which is a method of growing plants in a nutrient rich solution instead of soil, is a promising solution to food shortage given the scarcity of agricultural land to meet rising demands for food.

Hydroponics systems can be categorized into two main types: solution culture hydroponics and medium culture hydroponics. The latter is the dominant type and requires a solid medium (such as a substrate) to support seed germination and plant growth. The ideal hydroponics solid substrate should be: 1) biodegradable and eco-friendly, 2) highly porous for gas exchange and water retention, 3) capable of retaining nutrients, 4) able to mitigate plant pathogens, 5) lightweight, and 6) low cost.

The currently used support substrates for hydroponics are mainly based on rock wool, coco peat, sand, expanded clay, glass wool and synthetic polymers such as polyurethane, polystyrene and polyethylene etc. Each of these substrates has its own drawbacks. For example, rock wool, one of the most widely used substrates, is prone to producing small dust particles that can cause human health issues upon inhalation; it is non-biodegradable and hence not environmentally friendly. Additionally, rock wool can lead to a high pH value of around 8 requiring a pre-soaking process in pH adjusted water before use. Sand is heavy and requires additional containers to preserve its shape. Furthermore, sand only retains water for a short time and needs to be watered frequently. Synthetic polymers such as polystyrene and polyethylene are not readily biodegradable, resulting in plastic pollution. Moreover, some of the above substrates are solids with limited porosities, which limit nutrient flow and fluid exchange. This can lead to stagnant water accumulation around plants' roots. Therefore, stagnant water is a main challenge in hydroponics culture that can cause chlorosis, pallor, retarded growth and eventual death.

There is therefore a need to develop support substrates that can overcome, or at least ameliorate, one or more of the disadvantages described above. There is also a need to develop substrates with improved properties or even the ideal substrates for plant growth and hydroponics applications.

### SUMMARY OF INVENTION

In one aspect, the present disclosure refers to a substrate comprising:
(a) keratin derivative; and
(b) natural biopolymer,
wherein the keratin derivative and natural biopolymer are crosslinked.

Advantageously, the substrate may comprise a keratin derivate derived from any keratin source. Keratins may be extracted from hair, nails, feather, horns, hooves, wool etc. Many of these sources may come from farm waste. Thus, developing keratin-based substrates for agriculture and farm applications is a realistic strategy of recycling natural wastes, saving on cost and is in alignment with the concept of circular economy. Also, the keratin used is eco-friendly with good biocompatibility and biodegradability.

Also advantageously, with the incorporation of a natural biopolymer, the mechanical properties of the keratin-based substrate may be improved because of their crystalline domains and the potential for physical crosslinks with keratins through hydrogen bonds and electrostatic interactions. Further, the incorporation of natural biopolymers could enhance the water retention ability of keratin-based substrates owing to their significant amounts of hydroxyl (—OH) groups.

Further advantageously, substrates of the present disclosure may possess desired properties such as high porosity, biodegradability, be lightweight, potential for cationic compound binding and release, improved water retention and pathogen mitigation ability. The substrates may be porous and mechanically stable keratin-based substrates for supporting seed germination and plant growth in a hydroponics culture system and the keratin-based substrates as a reservoir for controlled release of micronutrients or macronutrients to enhance plant growth and immunity. Micronutrients or macronutrients may be incorporated in the substrate to enhance plant resistance to diseases or to provide a reservoir for micronutrients/macronutrients. In addition, some micronutrients or macronutrients may further improve the mechanical property of keratin/natural biopolymer composites. Therefore, the keratin-based substrates could be ideal support substrates for supporting plant growth in hydroponics culture systems. The substrate may also advantageously comprise bioactives for absorption by the plant and for later consumption by human/animals to confer health benefits. The substrate may further advantageously comprise pesticides for deterring, incapacitating, killing, or otherwise discouraging pests.

In another aspect, the present disclosure also relates to the use of the substrate as a plant growth medium, or hydronic support medium.

In another aspect, the present disclosure refers to a method of forming a substrate of any one of the preceding claims, wherein the method comprises:
(i) mixing a solution of keratin derivative with a solution of natural biopolymer; and
(ii) drying the resulting solution of step (i) to obtain the substrate.

Advantageously, the method may be simple, easy to perform and less laborious. Also advantageously, the method is cost effective, green and less toxic.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, the terms “keratin intermediate filaments (KIFs)”, “keratin intermediate filament proteins (KIFP)” or “keratin filaments” are cytoskeletal structural components composed of keratin proteins.

As used herein, the term “natural biopolymer(s)” refers to natural polymers produced by the cells of living organisms, which consist of monomeric units that are covalently bonded to form larger molecules.

As used herein, the term “crosslink” or “crosslinked” refers to a connection between keratin derivative and natural biopolymer or between the keratin derivatives themselves. The term “crosslink” or “crosslinked” refers to a portion or residue of the keratin derivative by which the natural biopolymer is covalently linked, and vice versa. The crosslink may either be a chemical bond (e.g., covalent or ionic bond) and/or a physical bond (e.g., molecules entanglement, hydrogen bond, hydrophobic interaction, or crystallization of polymer chain). Crosslinks may exist between separate molecules and may also exist between different points of the same molecule.

As used herein, the term “modified” refers to any deviation in the chemical structure from the natural biopolymer. For example, an oligonucleotide comprising at least one modified internucleoside linkage, a modified sugar, and/or a modified nucleobase; a peptide containing at least one unnatural amino acid or unnatural peptide linkage; a polysaccharide with at least one unnatural monosaccharide unit or glycosidic linkage. This term also includes any deviation/modification to existing functional groups on natural biopolymers, or the addition of new functional groups, for example hydroxyl, amine, carboxyl, thiol, aldehyde, ester, ether, and/or methacrylate.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1 shows a schematic image of a keratin-based substrate of the present invention and how it may be applied as a substrate in a hydroponic culture system to support plant growth.

FIGS. 2A to 2C show various keratin-based substrates of the present invention compared with a commercial hydroponics substrate (Oasis Cube).

FIG. 3 shows the microporous structure of sponges determined by Scanning Electron Microscopy (SEM). The sponges comprise pure KIF, pure CNF, KIF/CNF (weight percentage ratio 1.25:0.5), and KIF/CNF/CuO nanoparticles (NPs) (0.5 mg/ml CuO (particle size<50 nm)).

FIG. 4 shows the microporous structure of a sponge comprising KIF/C-dots (particle size<10 nm) having 0.5 mg/ml of C dots.

FIG. 5A shows the Fourier Transform Infrared Spectroscopy (FTIR) spectra of pure KIF and KIF/CNF sponges with weight percentage ratios of 1.25:0.25 and 1.25:0.75; and FIG. 5B shows the FTIR spectra of pure KIF, KIF/CuO NPs and KIF/C dots (0.5 mg/ml C dots).

FIG. 6 shows the FTIR spectra of pure KIF, KIF/CNF, KIF/CNF/C dots, and KIF/CNF/CuO NPs.

FIGS. 7A and 7C show representative strain-stress curves obtained using an Instron Mechanical Tester 5567 (Instron Co., Norwood, Mass., USA) with a compressive method of (A) pure KIF and KIF/CNF sponges containing KIF and CNF with weight percentage ratios of 1.25:0.25, 1.25:0.50 and 1.25:0.75 and (C) pure KIF, and KIF/CNF/CuO sponges. FIGS. 7B and 7D show the compressive strengths of (B) pure KIF and KIF/CNF sponges containing KIF and CNF with weight percentage ratios of 1.25:0.25, 1.25:0.50 and 1.25:0.75 and (D) the compressive strengths of pure KIF and KIF/CNF containing 0.5 mg/ml CuO NPs where the values were measured at 80% strain.

FIGS. 8A to 8B show the behaviour of pure KIF, KIF/CNF and KIF/CNF/C dots sponges in deionized (DI) water: (A) Water uptake ratio of sponges within 25 hours, where commercial Oasis Cube was used as positive control (sharp increase at the 25 hours mark was due to mechanical squeezing of air bubbles from the KIF/CNF sponge), and (B) weight loss of pure KIF and KIF/CNF (1.25 wt % of KIF and 0.5 wt % of CNF) sponges in DI water within 10 days.

FIG. 9 shows the shape memory properties and mechanical resilience of the KIF/CNF, KIF/CuO NPs, and KIF/CNF/CuO sponges after being immersed in DI water for one day.

FIG. 10 shows the ion release profile into water for various keratin-based sponges including pure KIF, and KIF/CNF/CuO for 10 days.

FIG. 11 shows keratin-based sponges as substrates to support mung beans germination and growth where the support substrates used are cotton wool, pure KIF, KIF/CuO NPs, KIF/CNF, KIF/CNF/CuO and KIF/CNF/C-dots sponges.

FIGS. 12A and 12B show the plant growth assessment on keratin-based substrates using Arabidopsis seeds, over 14 days, where FIG. 12A illustrates the photographs of Arabidopsis growing on various keratin-based substrates at 3 and 14 days, and FIG. 12B shows the shoot length of Arabidopsis seedlings measured at 14 days. *Significant difference (p<0.05, n=6).

### DETAILED DISCLOSURE OF EMBODIMENTS

The present invention describes a keratin-based substrate useful for supporting seed germination and plant growth in a hydroponics culture environment. The substrate may comprise keratin derivatives (such as keratin intermediate filaments proteins (KIFPs)), natural biopolymers (such as cellulose nanofibers) and optionally various micronutrients, macronutrients, pesticides and/or bioactives. The keratin-based substrate may be a keratin-based nanocomposite or a keratin-based sponge.

The present invention relates to a substrate comprising:

(a) keratin derivative; and

(b) natural biopolymer,

wherein the keratin derivative and natural biopolymer are crosslinked.

The keratin derivative and natural biopolymer may be crosslinked via hydrogen bonds between the amine group(s) on the keratin derivative and hydroxyl group(s) on the natural biopolymer. The keratin derivative and natural biopolymer may also be crosslinked via electrostatic interactions between the keratin derivative and natural biopolymer. The keratin derivative and natural biopolymer may also be crosslinked via amide bonds between amine and carboxyl groups, via schiff base bonds between amine groups on the keratin derivative and natural biopolymers modified with aldehydes, via thiol-ene reaction by forming sulphide bonds between thiol groups on the keratin derivative and natural biopolymers that contain C═C bonds, or via addition polymerization between the keratin derivative and natural biopolymers after modification with methacrylates.

The substrate may be in the form of a porous sponge. The substrate or sponge may be useful for supporting hydroponics plant growth. The substrate or sponge may be porous and mechanically stable for supporting seed germination and plant growth in a hydroponics culture system. The substrate or sponge may be used as a reservoir for the controlled release of micronutrients, macronutrients, pesticides and/or bioactives. The micronutrients and/or macronutrients may enhance plant growth and immunity. The bioactives may be included in the substrate or sponge for absorption by the plant and for later consumption by humans/animals to confer health benefits.

The keratin derivative may be selected from the group consisting of keratin intermediate filament protein (KIF), kerateine, keratose, and combinations thereof. The KIF may be free or substantially free of keratin-associated proteins (KAP). The KIF protein may be pure KIF protein.

The keratin derivative may be derived from any human and/or animal source such as from hair, nails, wool, horn, fur, hooves, feathers, scales, or combinations thereof.

The natural biopolymer may be a modified natural biopolymer. The modified natural biopolymer may be any natural biopolymer that has any deviation in its chemical structure, such as any modification to existing functional groups on the natural biopolymer, or addition of new functional groups on the natural biopolymer. For example, the natural biopolymer may be modified to comprise additional hydroxyl, amine, carboxyl, thiol, aldehyde, and/or methacrylate groups. The natural biopolymer may be modified to add any group which aids with crosslinking to the keratin derivative.

The natural biopolymer or modified natural biopolymer comprises hydroxyl, amine, carboxyl, thiol, aldehyde, and/or methacrylate groups.

The natural biopolymer may be selected from the group consisting of cellulose, modified cellulose, nanocellulose, modified nanocellulose, chitosan, modified chitosan, chitin, modified chitin, collagen, modified collagen, fibrinogen, modified fibrinogen, polysaccharide, modified polysaccharide, starch, modified starch, alginate, modified alginate, silk fibroin, modified silk fibroin, sericin, modified sericin, pullulan, modified pullulan, and combinations thereof.

The nanocellulose may be selected from the group consisting of cellulose nanocrystals, modified cellulose nanocrystals, cellulose nanofibrils, modified cellulose nanofibrils, bacterial nanocellulose, and modified bacterial nanocellulose.

The cellulose, nanocellulose or cellulose nanofibrils may be modified to comprise additional hydroxyl, amine, carboxyl, thiol, aldehyde, and/or methacrylate groups.

Keratins are a class of specialised proteins evolved by nature to form structural coverings on the body surfaces of mammals. In vitro, keratins have been fabricated into various forms such as sponges, films and hydrogels for biomedical applications due to their biocompatibility and biodegradability. However, keratins have not been used as support substrates for hydroponics applications. Keratins can be extracted from hair, nails, feather, horns, hooves and wool etc. Many of these are farm wastes. Thus, developing keratin-based substrates for agricultural applications is a realistic strategy of recycling natural waste and is in alignment with the concept of circular economy. In addition, keratin is composed of various amino acids such as glycine, alanine and cysteine, providing active chemical functional groups such as —SH and —COOH, which could advantageously be exploited to bind cationic active ingredients such as plant micronutrients, thereby functioning as a store for controlled release of micronutrients. Furthermore, keratin is eco-friendly with good biocompatibility and biodegradability.

Notwithstanding the above, poor mechanical properties and low water uptake potential of keratins alone could impede their use as support substrates for hydroponics. To mitigate these shortfalls, the inventors have surprisingly found that natural biopolymers, such as nanofibrous biopolymers or cellulose nanofibers, could be incorporated into the keratin matrix to obtain keratin-nanocellulose composites. As a common type of natural biopolymer, cellulose can be easily obtained from various plant materials such as cotton, wood pulp, vegetable trimmings etc. by chemical and physical methods. On one hand, nanocellulose incorporation could improve the mechanical properties of a keratin alone matrix because of their crystalline domains and the potential for physical crosslinks with keratins through hydrogen bonds and electrostatic interactions. On the other hand, nanocellulose could enhance water retention ability of keratin-based composites owing to their significant amounts of —OH groups. With regard to agricultural applications, nanocellulose has been previously fabricated into hydrogels for sesame seed germination. However, this cellulose hydrogel with nano-sized pores have limited porosity for gas and water exchange, and are therefore not suitable to be used as support substrates for hydroponics.

Cellulose as natural biopolymers found in plants have received much attention over the last two decades due to its renewable ability, biodegradability and biocompatibility. The crystalline domains, intramolecular and intermolecular hydrogen bonds formed among —OH groups play vital roles in governing cellulose's solubility and mechanical properties. Nanocellulose presents unusual properties such as high specific surface area and elastic modulus, and low density. Nanocellulose can be generally classified into three types: cellulose nanocrystals (CNCs), cellulose nanofibrils (CNFs) and bacterial nanocellulose (BNC). CNF may be obtained by mechanical grinding (physical method) from wood fibres.

Pure keratin materials suffer from weak mechanical properties such that they cannot fully meet the requirements as support substrates to support plant growth in a water logged environment. Thus, in the present invention, cellulose nanofibrils (CNF) may be incorporated into keratin matrices not only to improve their mechanical property, but also to enhance their water uptake ability by introducing additional hydroxyl functional groups.

The molecular weight of the keratin derivative may be about 40 kDa to about 60 kDa, about 45 kDa to about 60 kDa, about 50 kDa to about 60 kDa, about 55 kDa to about 60 kDa, about 40 kDa to about 55 kDa, about 40 kDa to about 50 kDa, about 40 kDa to about 45 kDa, about 40 kDa, about 41 kDa, about 42 kDa, about 43 kDa, about 44 kDa, about 45 kDa, about 46 kDa, about 47 kDa, about 48 kDa, about 49 kDa, about 50 kDa, about 51 kDa, about 52 kDa, about 53 kDa, about 54 kDa, about 55 kDa, about 56 kDa, about 57 kDa, about 58 kDa, about 59 kDa, or about 60 kDa, or any value or range therebetween.

The substrate may comprise about 0.5 wt % to about 2.0 wt %, about 0.6 wt % to about 2.0 wt %, about 0.7 wt % to about 2.0 wt %, about 0.8 wt % to about 2.0 wt %, about 0.9 wt % to about 2.0 wt %, about 1.0 wt % to about 2.0 wt %, about 1.1 wt % to about 2.0 wt %, about 1.2 wt % to about 2.0 wt %, about 1.3 wt % to about 2.0 wt %, about 1.4 wt % to about 2.0 wt %, about 1.5 wt % to about 2.0 wt %, about 1.6 wt % to about 2.0 wt %, about 1.7 wt % to about 2.0 wt %, about 1.8 wt % to about 2.0 wt %, about 1.9 wt % to about 2.0 wt %, about 0.5 wt % to about 1.9 wt %, about 0.5 wt % to about 1.8 wt %, about 0.5 wt % to about 1.7 wt %, about 0.5 wt % to about 1.6 wt %, about 0.5 wt % to about 1.5 wt %, about 0.5 wt % to about 1.4 wt %, about 0.5 wt % to about 1.3 wt %, about 0.5 wt % to about 1.2 wt %, about 0.5 wt % to about 1.1 wt %, about 0.5 wt % to about 1.0 wt %, about 0.5 wt % to about 0.9 wt %, about 0.5 wt % to about 0.8 wt %, about 0.5 wt % to about 0.7 wt %, about 0.5 wt % to about 0.6 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt % keratin derivative, or any value or range therebetween, based on the total weight of the substrate.

The substrate may comprise about 0.25 wt % to about 1.0 wt %, about 0.30 wt % to about 1.0 wt %, about 0.35 wt % to about 1.0 wt %, about 0.40 wt % to about 1.0 wt %, about 0.45 wt % to about 1.0 wt %, about 0.50 wt % to about 1.0 wt %, about 0.55 wt % to about 1.0 wt %, about 0.60 wt % to about 1.0 wt %, about 0.65 wt % to about 1.0 wt %, about 0.70 wt % to about 1.0 wt %, about 0.75 wt % to about 1.0 wt %, about 0.80 wt % to about 1.0 wt %, about 0.85 wt % to about 1.0 wt %, about 0.90 wt % to about 1.0 wt %, about 0.95 wt % to about 1.0 wt %, about 0.25 wt % to about 0.95 wt %, about 0.25 wt % to about 0.90 wt %, about 0.25 wt % to about 0.85 wt %, about 0.25 wt % to about 0.80 wt %, about 0.25 wt % to about 0.75 wt %, about 0.25 wt % to about 0.70 wt %, about 0.25 wt % to about 0.65 wt %, about 0.25 wt % to about 0.60 wt %, about 0.25 wt % to about 0.55 wt %, about 0.25 wt % to about 0.50 wt %, about 0.25 wt % to about 0.45 wt %, about 0.25 wt % to about 0.40 wt %, about 0.25 wt % to about 0.35 wt %, about 0.25 wt % to about 0.30 wt %, about 0.25 wt %, about 0.30 wt %, about 0.35 wt %, about 0.40 wt %, about 0.45 wt %, about 0.50 wt %, about 0.55 wt %, about 0.60 wt %, about 0.65 wt %, about 0.70 wt %, about 0.75 wt %, about 0.80 wt %, about 0.85 wt %, about 0.90 wt %, about 0.95 wt %, or about 1.0 wt % natural biopolymer, or any value or range therebetween, based on the total weight of the substrate.

The weight percentage ratio of keratin derivative to natural biopolymer in the substrate may be about 5:1 to about 5:3, about 5:1 to about 5:2, about 5:2 to about 5:3, about 5:1, about 5:2, or about 5:3, or any value or range therebetween.

The substrate may further comprise (c) micronutrients, macronutrients, pesticides and/or bioactives.

Advantageously, the substrates of the present invention may allow for the incorporation of all kinds of nutrients, for example, nutrients that are advantageous to plants, humans, and/or animals. Nutrients for supporting plant health (such as fertilisers) may be incorporated into the substrate, and/or nutrients such as omega 3, folic acid, or calcium may be added to the substrate for absorption by plants and for later consumption by humans/animals to confer health benefits.

Various nanoparticles (NPs) may be incorporated into the substrates to obtain functional nanocomposite substrates. NPs with specific functions could be used to enhance plant resistance to diseases or to provide a reservoir for micronutrients. In addition, some NPs could further improve the mechanical property of the substrates.

Nanoparticles (NPs) such as Fe₂O₃, CuO, TiO₂, ZnO, silica and carbon dots etc. have been developed as fertilizers and pesticides to enhance plant growth by direct introduction into soil. While efficacy has been demonstrated, this approach is non-targeted and results in excessive amounts of these NPs polluting the environment. In the present invention, NPs may be incorporated as nutrients within the substrate (or sponge) in order to bind them to the solid substrate and create a medium for controlled and targeted release of these nutrients to the plants. The specific function of each NP that is incorporated into keratin/cellulose composites will be detailed below.

ZnO and Fe₂O₃ NPs as fertilizer may result in greater seed germination and root growth of peanut seeds. Silica NPs are better at for insect control compared with bulk silica. TiO₂ NPs may reduce bacterial spot disease during plant growth. CuO NPs may effectively suppress bacteria growth plants. Carbon dots enhance disease resistance. Such functional NPs may be incorporated into the substrate (or sponge). The NPs may have sizes varying from a few nm to a few hundred nm. Advantageously, NPs with different particle sizes provide a range of specific surface areas, leading to different release kinetics of the nutrients from the substrates (or sponges) when hydrated, which could have differing impact on plant growth. For example, smaller NPs with larger specific surface areas may have a faster release rate of micronutrients.

The micronutrient may be selected from the group consisting of metal oxides, metal salts, silica, carbon dots, and combinations thereof.

The metal may be selected from the group consisting of zinc, copper, iron, magnesium, manganese, titanium, molybdenum, cobalt, nickel, silver, gold, and combinations thereof.

The micronutrients may be manganese, boron, copper, iron, zinc, nickel, molybdenum or chlorine micronutrients. The micronutrient may be selected from the group consisting of copper oxide (CuO), zinc oxide (ZnO), iron oxide (Fe₂O₃), carbon dots, silica (SiO₂), and titanium oxide (TiO₂).

The macronutrient may be nitrogen, phosphorus, potassium, calcium, magnesium, and sulfur macronutrients.

The pesticide may be any substance which can control pests. The pesticide may selected from the group consisting of herbicides, insecticides, ematicides, molluscicides, piscicides, avicides, rodenticides, bactericides, insect repellents, animal repellents, antimicrobials, fungicides, aligicides, algaecides, miticides, acaricides, nematicides, slimicides, larvicides, and virucides. The pesticide may be selected from the group consisting of organochlorines, organophosphates, carbamates, pyrethroids, sulfonylurea herbicies, and biopesticides. The pesticide may be selected from the group consisting of Glyphosate, Boscalid, Acephate, Deet, Propoxur, Metaldehyde, Boric Acid, Diazinon, Dursban, DDT, and Malathion.

The bioactive may be selected from the group consisting of biomolecules, antimicrobial agents, omega 3, folic acid, boron and calcium.

The micronutrient may have an average diameter of about 1 nm to about 500 nm, about 50 nm to about 500 nm, about 100 nm to about 500 nm, about 150 nm to about 500 nm, about 200 nm to about 500 nm, about 250 nm to about 500 nm, about 300 nm to about 500 nm, about 350 nm to about 500 nm, about 400 nm to about 500 nm, about 450 nm to about 500 nm, about 1 nm to about 450 nm, about 1 nm to about 400 nm, about 1 nm to about 350 nm, about 1 nm to about 300 nm, about 1 nm to about 250 nm, about 1 nm to about 200 nm, about 1 nm to about 150 nm, about 1 nm to about 100 nm, about 1 nm to about 50 nm, about 1 nm, about 10 nm, about 20 nm, about 30 nm, about 40 nm, about 50 nm, about 60 nm, about 70 nm, about 80 nm, about 90 nm, about 100 nm, about 110 nm about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, or any value or range therebetween.

The micronutrient concentration in the substrate may be about 0.005 mg/ml to about 1.0 mg/ml, about 0.005 mg/ml to about 0.9 mg/ml, about 0.005 mg/ml to about 0.8 mg/ml, about 0.005 mg/ml to about 0.7 mg/ml, about 0.005 mg/ml to about 0.6 mg/ml, about 0.005 mg/ml to about 0.5 mg/ml, about 0.005 mg/ml to about 0.4 mg/ml, about 0.005 mg/ml to about 0.3 mg/ml, about 0.005 mg/ml to about 0.2 mg/ml, about 0.005 mg/ml to about 0.1 mg/ml, about 0.005 mg/ml to about 0.05 mg/ml, about 0.005 mg/ml to about 0.01 mg/ml, about 0.01 mg/ml to about 1.0 mg/ml, about 0.05 mg/ml to about 1.0 mg/ml, about 0.1 mg/ml to about 1.0 mg/ml, about 0.2 mg/ml to about 1.0 mg/ml, about 0.3 mg/ml to about 1.0 mg/ml, about 0.4 mg/ml to about 1.0 mg/ml, about 0.5 mg/ml to about 1.0 mg/ml, about 0.6 mg/ml to about 1.0 mg/ml, about 0.7 mg/ml to about 1.0 mg/ml, about 0.8 mg/ml to about 1.0 mg/ml, about 0.9 mg/ml to about 1.0 mg/ml, about 0.005 mg/ml, about 0.01 mg/ml, about 0.05 mg/ml, about 0.1 mg/ml, about 0.2 mg/ml, about 0.3 mg/ml, about 0.4 mg/ml, about 0.5 mg/ml, about 0.6 mg/ml, about 0.7 mg/ml, about 0.8 mg/ml, about 0.9 mg/ml, about 1.0 mg/ml, or any value or range therebetween.

The macronutrient concentration in the substrate may be about 1 mg/ml to about 50 mg/ml, about 5 mg/ml to about 50 mg/ml, about 10 mg/ml to about 50 mg/ml, about 15 mg/ml to about 50 mg/ml, about 20 mg/ml to about 50 mg/ml, about 25 mg/ml to about 50 mg/ml, about 30 mg/ml to about 50 mg/ml, about 35 mg/ml to about 50 mg/ml, about 40 mg/ml to about 50 mg/ml, about 45 mg/ml to about 50 mg/ml, about 1 mg/ml to about 45 mg/ml, about 1 mg/ml to about 40 mg/ml, about 1 mg/ml to about 35 mg/ml, about 1 mg/ml to about 30 mg/ml, about 1 mg/ml to about 25 mg/ml, about 1 mg/ml to about 20 mg/ml, about 1 mg/ml to about 15 mg/ml, about 1 mg/ml to about 10 mg/ml, about 1 mg/ml to about 5 mg/ml, or about 1 mg/ml, about 2 mg/ml, about 3 mg/ml, about 4 mg/ml, about 5 mg/ml, about 6 mg/ml, about 7 mg/ml, about 8 mg/ml, about 9 mg/ml, about 10 mg/ml, about 11 mg/ml, about 12 mg/ml, about 13 mg/ml, about 14 mg/ml, about 15 mg/ml, about 16 mg/ml, about 17 mg/ml, about 18 mg/ml, about 19 mg/ml, about 20 mg/ml, about 21 mg/ml, about 22 mg/ml, about 23 mg/ml, about 24 mg/ml, about 25 mg/ml, about 26 mg/ml, about 27 mg/ml, about 28 mg/ml, about 29 mg/ml, about 30 mg/ml, about 31 mg/ml, about 32 mg/ml, about 33 mg/ml, about 34 mg/ml, about 35 mg/ml, about 36 mg/ml, about 37 mg/ml, about 38 mg/ml, about 39 mg/ml, about 40 mg/ml, about 41 mg/ml, about 42 mg/ml, about 43 mg/ml, about 44 mg/ml, about 45 mg/ml, about 46 mg/ml, about 47 mg/ml, about 48 mg/ml, about 49 mg/ml, about 50 mg/ml, or any value or range therebetween.

The pesticide concentration in the substrate may be about 0.005 mg/ml to about 1.0 mg/ml, about 0.005 mg/ml to about 0.9 mg/ml, about 0.005 mg/ml to about 0.8 mg/ml, about 0.005 mg/ml to about 0.7 mg/ml, about 0.005 mg/ml to about 0.6 mg/ml, about 0.005 mg/ml to about 0.5 mg/ml, about 0.005 mg/ml to about 0.4 mg/ml, about 0.005 mg/ml to about 0.3 mg/ml, about 0.005 mg/ml to about 0.2 mg/ml, about 0.005 mg/ml to about 0.1 mg/ml, about 0.005 mg/ml to about 0.05 mg/ml, about 0.005 mg/ml to about 0.01 mg/ml, about 0.01 mg/ml to about 1.0 mg/ml, about 0.05 mg/ml to about 1.0 mg/ml, about 0.1 mg/ml to about 1.0 mg/ml, about 0.2 mg/ml to about 1.0 mg/ml, about 0.3 mg/ml to about 1.0 mg/ml, about 0.4 mg/ml to about 1.0 mg/ml, about 0.5 mg/ml to about 1.0 mg/ml, about 0.6 mg/ml to about 1.0 mg/ml, about 0.7 mg/ml to about 1.0 mg/ml, about 0.8 mg/ml to about 1.0 mg/ml, about 0.9 mg/ml to about 1.0 mg/ml, about 0.005 mg/ml, about 0.01 mg/ml, about 0.05 mg/ml, about 0.1 mg/ml, about 0.2 mg/ml, about 0.3 mg/ml, about 0.4 mg/ml, about 0.5 mg/ml, about 0.6 mg/ml, about 0.7 mg/ml, about 0.8 mg/ml, about 0.9 mg/ml, about 1.0 mg/ml, or any value or range therebetween.

The bioactive concentration in the substrate may be about 0.005 mg/ml to about 1.0 mg/ml, about 0.005 mg/ml to about 0.9 mg/ml, about 0.005 mg/ml to about 0.8 mg/ml, about 0.005 mg/ml to about 0.7 mg/ml, about 0.005 mg/ml to about 0.6 mg/ml, about 0.005 mg/ml to about 0.5 mg/ml, about 0.005 mg/ml to about 0.4 mg/ml, about 0.005 mg/ml to about 0.3 mg/ml, about 0.005 mg/ml to about 0.2 mg/ml, about 0.005 mg/ml to about 0.1 mg/ml, about 0.005 mg/ml to about 0.05 mg/ml, about 0.005 mg/ml to about 0.01 mg/ml, about 0.01 mg/ml to about 1.0 mg/ml, about 0.05 mg/ml to about 1.0 mg/ml, about 0.1 mg/ml to about 1.0 mg/ml, about 0.2 mg/ml to about 1.0 mg/ml, about 0.3 mg/ml to about 1.0 mg/ml, about 0.4 mg/ml to about 1.0 mg/ml, about 0.5 mg/ml to about 1.0 mg/ml, about 0.6 mg/ml to about 1.0 mg/ml, about 0.7 mg/ml to about 1.0 mg/ml, about 0.8 mg/ml to about 1.0 mg/ml, about 0.9 mg/ml to about 1.0 mg/ml, about 0.005 mg/ml, about 0.01 mg/ml, about 0.05 mg/ml, about 0.1 mg/ml, about 0.2 mg/ml, about 0.3 mg/ml, about 0.4 mg/ml, about 0.5 mg/ml, about 0.6 mg/ml, about 0.7 mg/ml, about 0.8 mg/ml, about 0.9 mg/ml, about 1.0 mg/ml, or any value or range therebetween.

The substrate may have an average a pore size of about 100 μm to about 200 μm, about 110 μm to about 200 μm, about 120 μm to about 200 μm, about 130 μm to about 200 μm, about 140 μm to about 200 μm, about 150 μm to about 200 μm, about 160 μm to about 200 μm, about 170 μm to about 200 μm, about 180 μm to about 200 μm, about 190 μm to about 200 μm, about 100 μm to about 190 μm, about 100 μm to about 180 μm, about 100 μm to about 170 μm, about 100 μm to about 160 μm, about 100 μm to about 150 μm, about 100 μm to about 140 μm, about 100 μm to about 130 μm, about 100 μm to about 120 μm, about 100 μm to about 110 μm, about 100 μm, about 110 μm, about 120 μm, about 130 μm, about 140 μm, about 150 μm, about 160 μm, about 170 μm, about 180 μm, about 190 μm, about 200 μm, or any value or range therebetween.

The substrate may comprise:

(i) keratin intermediate filament protein;

(ii) cellulose nanofibrils; and

(iii) particulate micronutrients selected from the group consisting of metal oxides, metal salts, silica, carbon dots, and combinations thereof,

wherein the metal is selected from the group consisting of zinc, copper, iron, magnesium manganese, titanium, molybdenum, cobalt, nickel, silver, gold, and combinations thereof.

The substrate may comprise:
(i) keratin intermediate filament protein which is free or substantially free of KAP;
(ii) cellulose nanofibrils; and
(iii) micronutrients, macronutrients, pesticides and/or bioactives.

The substrate may comprise:
(i) keratin intermediate filament protein which is free or substantially free of KAP;
(ii) cellulose nanofibrils; and
(iii) particulate micronutrients selected from the group consisting of metal oxides, metal salts, silica, carbon dots, and combinations thereof, wherein the metal is selected from the group consisting of zinc, copper, iron, magnesium manganese, titanium, molybdenum, cobalt, boron, nickel, silver, gold, and combinations thereof.

The substrate may comprise:
(i) pure or substantially pure keratin intermediate filament protein;
(ii) cellulose nanofibrils; and
(iii) micronutrients, macronutrients, pesticides and/or bioactives.

The present disclosure also relates to the use of the substrate as a plant growth medium or hydroponic support medium.

In an embodiment, the keratin-based substrates are in the form of porous sponges for supporting hydroponic plants growth. The sponges are primarily composed of keratin intermediate filaments (KIF) proteins with molecular weight from 40-60 kDa and cellulose nanofibers (CNF) with diameters below 100 nm. In addition, functional micronutrients in the form of nanoparticles (NPs), ranging from a few nm to a few hundred nm, such as copper oxide (CuO), zinc oxide (ZnO), iron oxide (Fe₂O₃) and/or carbon dots (C-dot) may be incorporated into the sponges to enhance plant growth and build immunity against pathogens.

Overall, the substrates (sponges) fabricated in the present invention may possess the desired properties of high porosity, biodegradability, lightweight, potential for cationic compound binding and release, improved water retention and pathogen mitigation ability. Therefore, the substrates (sponges) could be ideal support substrates for supporting plant growth in hydroponics culture systems.

The present invention also relates to a method of forming a substrate comprising keratin derivative, natural biopolymer, where the keratin derivative and natural biopolymer are crosslinked, the method comprising:
(i) mixing a solution of keratin derivative with a solution of natural biopolymer; and
(ii) drying the resulting solution of step (i) to obtain the substrate.

The method may further comprise step (i′) dispersing micronutrients, macronutrients, pesticides and/or bioactives, into the solution of keratin derivative, wherein step (i′) occurs before step (i).

Step (ii) may comprise drying the resulting solution for at least 24 hours. The drying step may be a freeze drying step.

Step (ii) may comprise freeze drying the solution of step (i) at a temperature of about −10° C. to about −80° C., about −10° C. to about −70° C., about −10° C. to about −60° C., about −10° C. to about −50° C., about −10° C. to about −40° C., about −10° C. to about −30° C., about −10° C. to about −20° C., about −20° C. to about −80° C., about −30° C. to about −80° C., about −40° C. to about −80° C., about −50° C. to about −80° C., about −60° C. to about −80° C., about −70° C. to about −80° C., about −10° C., about −15° C., about −20° C., about −25° C., about −30° C., about −35° C., about −40° C., about −45° C., about −50° C., about −55° C., about −60° C., about −65° C., about −70° C., about −75° C., about −80° C., or any value or range therebetween.

To fabricate porous materials (such as sponges), a number of techniques such as electrospinning, 3D printing, solvent casting, and particulate leaching may be used. However, particulate-leaching methods can only produce thin templates due to difficulties in leaching out porogens from thick templates. 3D printing and electrospinning techniques require specialized equipment to produce porous templates. Among them, freeze drying method is advantageous for its simplicity, easy control of pore structure and low cost.

In an embodiment, the present invention relates to a method of producing keratin/nanocellulose/nanoparticles sponges as support substrates for hydroponics. The invention may comprise the steps of: a) dispersing micronutrient nanoparticles into mixtures of keratin-nanocellulose solutions in a single mixture; and b) freeze drying the resultant solution to fabricate porous keratin-based nanocomposites.

In an embodiment, the present invention also includes freeze drying the KIF/CNF/NPs hybrid solution to obtain porous nanocomposites. Freeze drying, otherwise termed as lyophilisation refers to a drying process in which a material is frozen to below 0° C. To get porous keratin-based nanocomposites, water in the form of ice crystals within the materials will be removed by sublimation with the surrounding pressure reducing. The pore structures including pore size and porosity are able to be adjusted by changing freeze temperature. The freeze temperatures could be set at −10, −20, −40 and −80° C. in the present invention, respectively. Different freeze temperatures would lead to nanocomposites having different pore structures.

Hereinafter, the present invention will be described in details based on the drawings, where exemplary embodiments of the invention are displayed. The present invention may be embodied in many different forms and should not be construed as limited to the exemplary embodiments set forth herein. These embodiments are provided so that this disclosure will be thorough and complete, and will fully convey the scope of the invention to those skilled in the art.

### EXAMPLES

Non-limiting examples of the invention will be further described in greater detail by reference to specific Examples, which should not be construed as in any way limiting the scope of the invention.

### Example 1: Extraction of KIF Proteins and Preparation of CNF and NPs

KIF was extracted from human hair using a reducing agent (dithiotreitiol (DTT)) for cleaving disulphide bonds of cysteine making keratin soluble in water-based buffer.

Firstly, keratin-associated protein (KAP) was removed from human hair. Finely cut human hair was dispersed in a reducing buffer containing urea, ethanol and DTT, and incubated for 72 hours at 50° C. with gentle shaking. The resultant solution was removed by filtration to obtain KAP-free hair. KAP-free hair was then dried at room temperature followed by incubation in another reducing buffer containing urea, thiourea, and DTT to extract KIF. After filtering to remove hair debris, KIF solution was dialyzed exhaustively against DI water to remove remaining reducing agents. The concentration of KIF proteins was measured by bicinchoninic acid assay before use.

CNF was obtained from wood fibres by a mechanical grinding method. The obtained CNF had a length of ˜300 nm and a diameter of ˜50 nm as determined by Transmission Electron Microscopy (TEM).

CuO NPs was purchased from Sigma-Aldrich (nanopowder, <50 nm particle size determined by TEM). Carbon dots used have a size of 3-7 nm.

### Example 2: Dispersing NPs into KIF-CNF Solutions

To disperse NPs with big size such as CuO and ZnO into KIF-CNF solution, probe sonication method was employed. After being dispersed by probe sonication, CuO NPs were stable in the solution without producing any big aggregates or precipitates for several hours. This time period was long enough for water-based solution to be completely frozen at temperature below −10° C. Carbon dots (C dots) were able to dissolve in water due to its small particle size (<10 nm). Thus, to disperse C dots within KIF-CNF solution, there was no need to perform any probe sonication or bath sonication. As an example, nanomaterials were mixed with keratin and cellulose together to obtain a concentration of 0.5 mg/ml.

### Example 3: Experimental Results of Keratin-Based Substrates

Keratin-based porous nanocomposites were produced by freezing the mixed solutions of KIF, CNF and NPs at −20° C. and freeze-drying to remove water crystals via sublimation. Variations in concentrations of each component were explored to obtain porous nanocomposites with different physicochemical properties in terms of pore structure, mechanical strength, water uptake capacity and degradation rate etc.

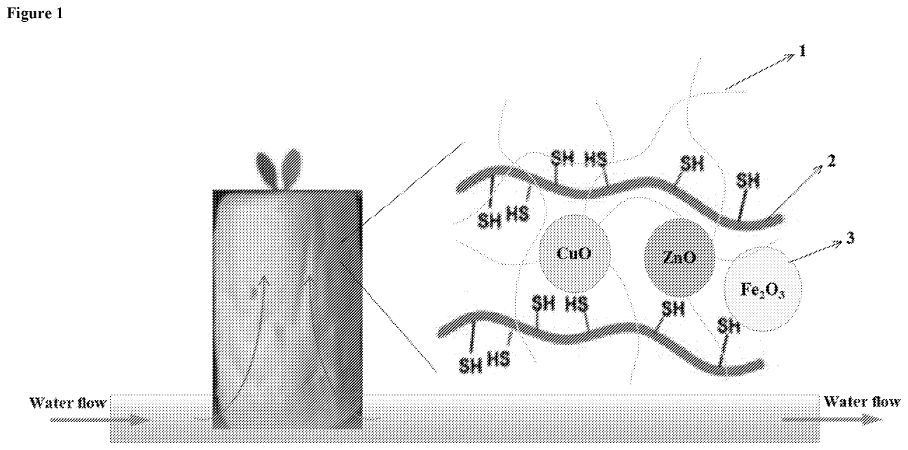

FIG. 1 shows how keratin-based sponges may be applied as substrates in a hydroponic culture system to support plants growth. FIG. 1 shows the potential combination in a keratin-based substrate of natural biopolymer (e.g. nanocellulose) (1), and keratin molecules (2) and micronutrient particles (3) including, but not limited to CuO, ZnO and Fe₂O₃ nanoparticles (NPs) through thiol groups. Keratin-based sponges being support substrates can absorb water as well as the nutrient ions from the flowing water to support plant growth. The keratin-based sponges could be a reservoir for nutrient ions due to the potential combination between thiol groups of keratin and metal ions. By forming these non-covalent bonds, nutrient ions could be released under a controlled manner into plants. Different nanoparticles with specific functions could also be incorporated into keratin-based substrates to provide plants micronutrients or a defence against pathogen. As shown in FIG. 1, keratin molecules could combine the nanoparticles including, but not limited to CuO, ZnO and Fe₂O₃ NPs through thiol, carboxyl groups on keratin molecules, and hydroxyl from cellulose.

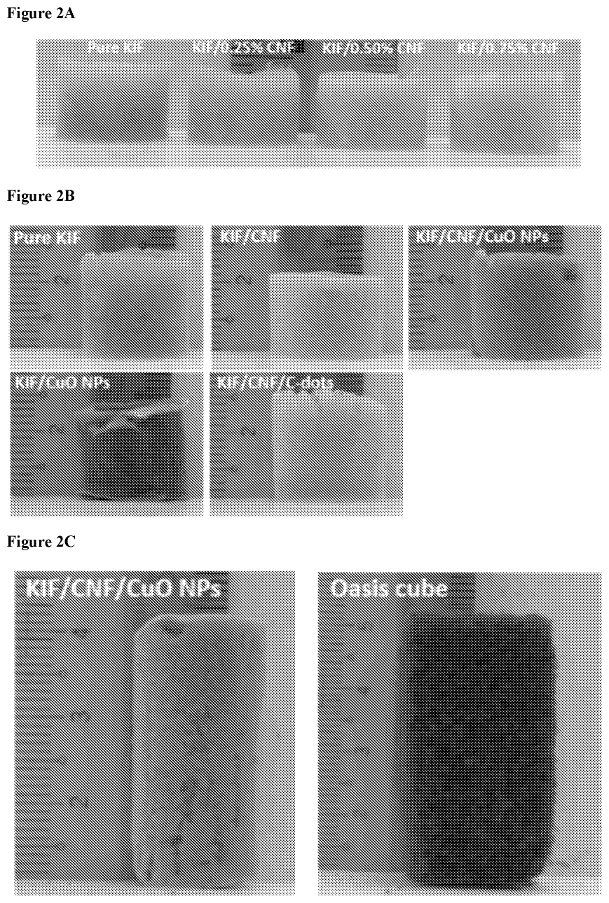

FIGS. 2A-2C show different types of keratin-based sponges where the different keratin-based substrates (or sponges) are in various weight percentages (%) ratios of keratin intermediate filaments (KIF) to cellulose nanofibers (CNF), (KIF:CNF) of 1.25:0.25, 1.25:0.50 and 1.25:0.75. The substrates (or sponges) having carbon dots (C dots, 0.5 mg/ml) or CuO NPs (0.5 mg/ml) contain 1.25 wt % of KIF and 0.5 wt % of CNF. To obtain these substrates, the mixed KIF-CNF-NPs solutions were frozen at −20° C. followed by freeze-drying of two days to remove water by sublimation. The obtained sponges were stable and took the shape of the moulds they were made in. As shown, these sponges are three dimensional with a diameter of 1.5 cm and a height of 1.0 cm, taking the shape of moulds. Therefore, keratin-based sponges' size may be adjusted just by changing the mould size. According to the size of commercial Oasis Cubes (2×2×4 cm), one of most popular substrates in hydroponic system, the inventors have prepared larger keratin-based sponges (KIF/CNF/CuO sponge with a size of ø 1.6×3 cm). These sponges with big size were used as prototypes for seed germination trials.

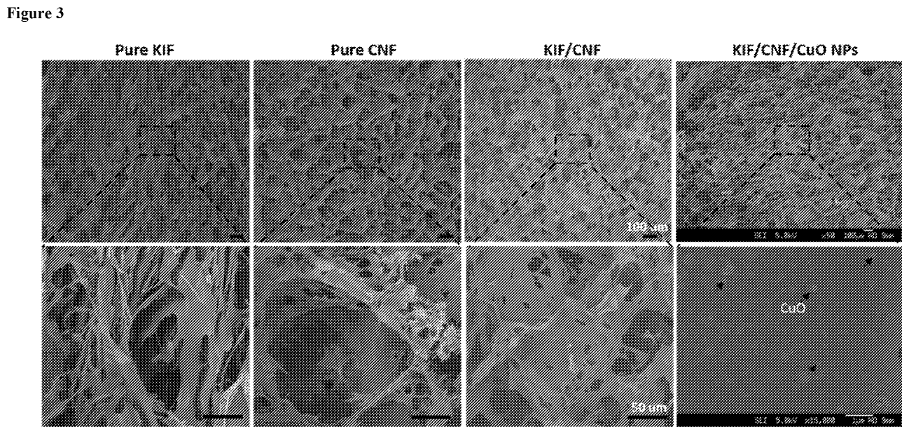

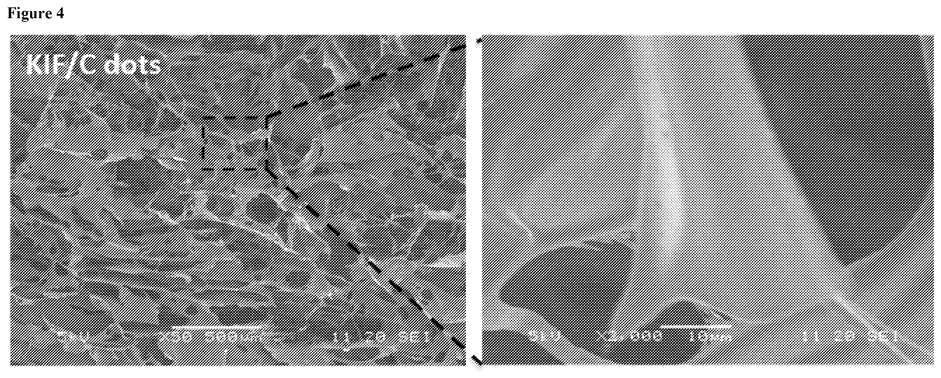

FIGS. 3 and 4 show the porous structure of the keratin-based sponges determined by SEM. The samples in FIGS. 3 and 4 were obtained by freezing the solutions at −20° C. and freeze-drying for 2 days. SEM images showed that all keratin-based sponges have microporous architectures with pore spaces that were highly interconnected. The interconnected pores throughout keratin-based sponges is beneficial for gas exchange and water recycling such that the stagnant water could be removed from hydroponic plants roots. The incorporation of CNF slightly changed the morphology of KIF to provide sponges with more homogeneous pore structure with pore size of 100-200 μm. The CuO NPs were presented in keratin-cellulose matrix as small aggregates with a uniform distribution. FIG. 4 shows that the pore structure of KIF/C dots sponge was similar to that of KIF/CNF sponge. However, C dots did not show in the images due to their smaller size 7-8 nm than that of CuO NPs. The keratin-based sponges may be fabricated at various freeze temperatures for optimizing their pore structure (e.g. pore size and porosity) so that water-gas exchange through the sponges can be improved.

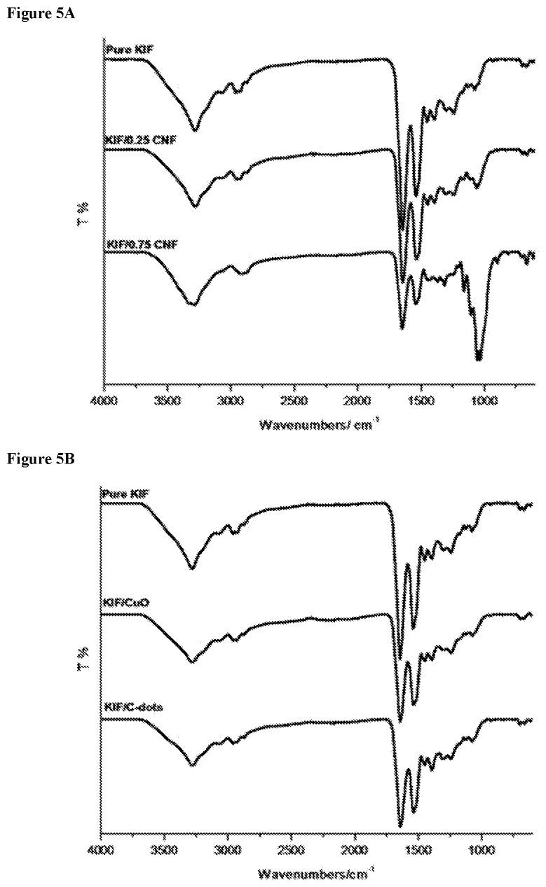

FIGS. 5A and 5B show the Fourier Transform Infrared Spectroscopy (FTIR) spectra of KIF/CNF, KIF/CuO and KIF/C dots sponges. The keratin-based sponges were evaluated by attenuated total reflection (ATR) technique between 4,000 and 600 cm⁻¹. Bands of Amide I (1645-1646 cm⁻¹), Amide II (1512-1515 cm⁻¹) and Amide III (1232-1237 cm⁻¹) were present in all keratin-based sponges. All these characteristics peaks belonging to keratins suggested that both CNF and NPs' incorporation did not change the integrity of the keratin protein and also there was no chemical alterations occurred to the keratin proteins during fabrication. The FTIR spectra of KIF/CNF sponges with different CNF content are presented in FIG. 5A. These spectra are a superposition of the spectra of the corresponding individual components. The intensities of these bands seems to correlate with the CNF concentration in the KIF/CNF composites. For example, the relative intensity of the band between 900 and 1200 cm⁻¹ (due to sugar ring deformation within cellulose molecules) increased with increasing concentration of CNF in the KIF/CNF composites.

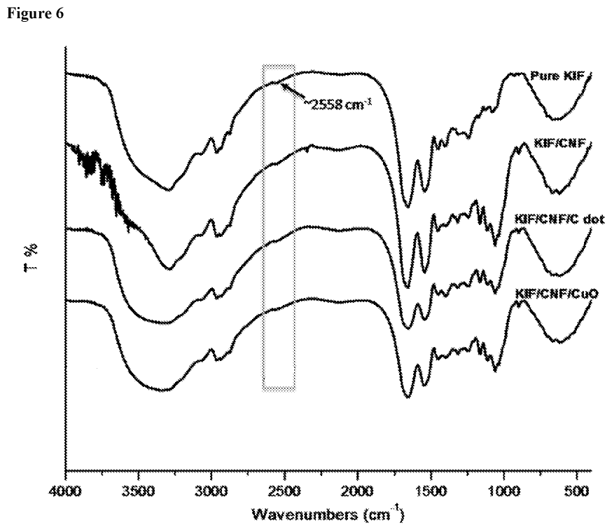

FIG. 6 shows the FTIR spectra of pure KIF, KIF/CNF, KIF/CNF/C-dots, and KIF/CNF/CuO NPs samples, prepared in KBr pellets. All these samples (FIG. 6) were prepared with KBr and the spectrum was recorded in transmission mode between 4,000 and 400 cm⁻¹. All bands of Amide I (1645-1646 cm⁻¹), Amide II (1512-1515 cm⁻¹) and Amide III (1232-1237 cm⁻¹) were present in all samples. Interestingly, the characteristic peak at around 2558 cm⁻¹, being ascribed to thiol groups in keratin was also present in the spectra of all keratin-based samples, while the thiol band was not seen in the spectra obtained by ATR mode FTIR analysis (FIG. 5). The reason is because ATR method only detects sample's surface and all thiol groups on surface could be oxidized into disulphide bonds due to sufficient oxygen from the atmosphere, but the KBr method could expose more thiols during sample preparation (grinding samples together with KBr powder to prepare a pellet). For the sample containing CuO NPs, the thiol bands did not disappear. This is possibly because the thiol groups could not form a bond with CuO NPs, in contrast to Cu ions. All these findings suggest that keratin-based substrates having active thiol groups could combine metal ions and regulate their release to achieve enhancement of plant growth.

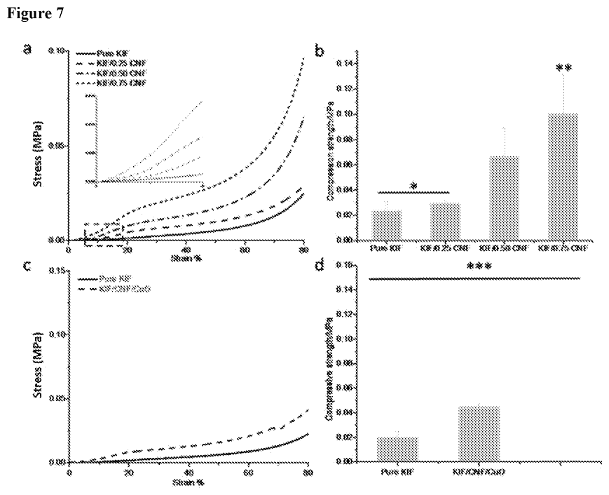

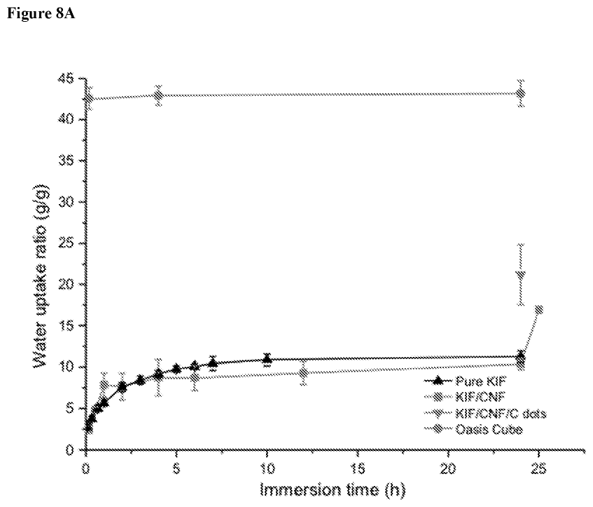

FIGS. 7A to 7D shows the compression strength of keratin-based sponges measured by Instron mechanical tester 5567 (Instron co., Massachusets) when the strain reached 80%. The results revealed that with increasing concentration of CNF, both compression strength and modulus of KIF/CNF sponges increased.

The cylindrical samples for the compressive test had a diameter of 1.5 cm and a height of 1 cm. Each type of keratin-based sponge had six duplicates. All the data is expressed as averages and the corresponding standard deviations.*No significant difference among the groups (p>0.05, n=6). **Significantly different from other groups except for KIF/0.50 CNF (p<0.05, n=6). ***Significantly different from each other (p<0.05, n=6).

The results demonstrate that an increasing concentration of CNF increase both compression strength and modulus of sponges (FIGS. 7A and 7B), suggesting that cellulose could improve the mechanical properties of keratin materials. The reason is likely the potential physical crosslinks formed between keratin and cellulose through hydrogen bonding and electrostatic interactions. The mechanical properties of keratin-based sponges containing nanomaterials have also been assessed in FIGS. 7C and 7D which shows enhanced mechanical property. The enhanced mechanical property could improve the integrity of keratin-based sponges in aqueous environment to support plant growth in the long term.

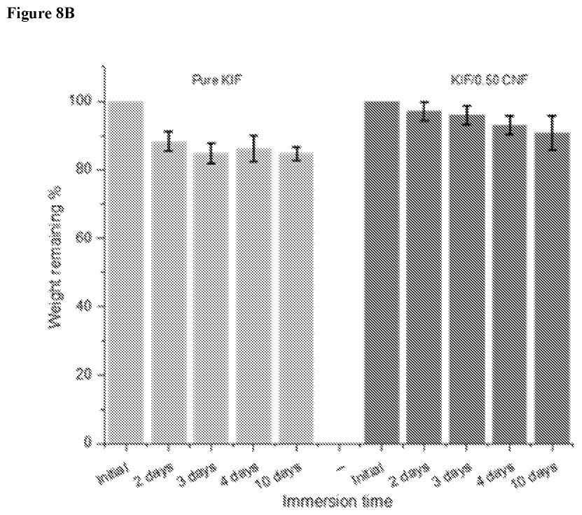

FIGS. 8A to 8B show the water uptake ratio and degradation of keratin-based sponges including pure KIF, and KIF/CNF samples in DI water. Water uptake ratio was assessed by measuring sample mass before and after being immersed in DI water and expressed as a mass percentage of swelling sponge to its dry sample. For water uptake ratio and degradation test, each sample had triplicates. There were no significant differences for the remaining weight at each time point. The results showed that incorporation of CNF increased water uptake ratio due to the huge amount of OH groups on cellulose molecules. As shown, KIF/CNF sponges have the ability of absorbing water up to ˜17 times its original weight while pure KIF only take water up to ˜12 times its original weight. FIG. 8B also depicts graphs of degradation rate for KIF/CNF sponges in DI water. KIF/CNF samples were taken out of water at each time point of immersion and freeze-dried in prior to weighing its mass. Differences in dry weight before and after being immersed into DI water were calculated to determine the amount of degradation. The results revealed that both KIF and KIF/CNF sponges were resistant to aqueous hydrolysis as their remaining weight after 10 days of immersion was still around 90% of their original weight.

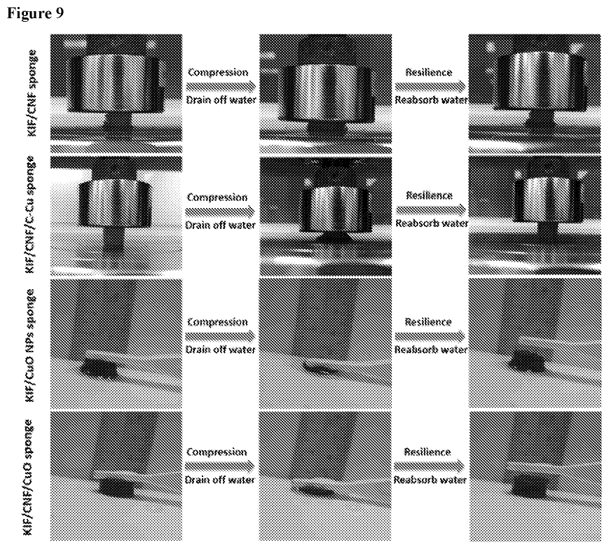

FIG. 9 shows the shape memory properties and fast resilience of the KIF/CNF, KIF/CuO NPs, and KIF/CNF/CuO sponges. The sponges contained 1.25 wt % of KIF, 0.5 wt % of CNF, 0.5 mg/ml CuO NPs. All these sponges, after absorbing water, are strongly resilient to mechanical compression, and could recover to their original state within 1-2 s of being compressed. This shape memory property was coupled with the ability to reabsorb the water that was squeezed out during compression. Further, this “compressing and water reabsorbing” process can be applied to wet sponges for at least 10 cycles without breaking the sponges, suggesting that these keratin-based sponges are robust. As shown in FIG. 9, all keratin-based sponges could recover to their initial state by simply reabsorbing the water that was squeezed out from the sponges after compressing. KIF/CNF sponges recovered immediately to their original shape within 2 s, while CuO NPs' incorporation even got the sponge recovered in less than 1 s. This “water-squeezing and reabsorbing” process were applied to the sponges for at least 10 cycles without causing any damage, indicating that keratin-based sponges was sort of robust. Importantly, the stagnant water within keratin-based sponges around hydroponic plants roots could be removed by this water-draining off and reabsorbing process.

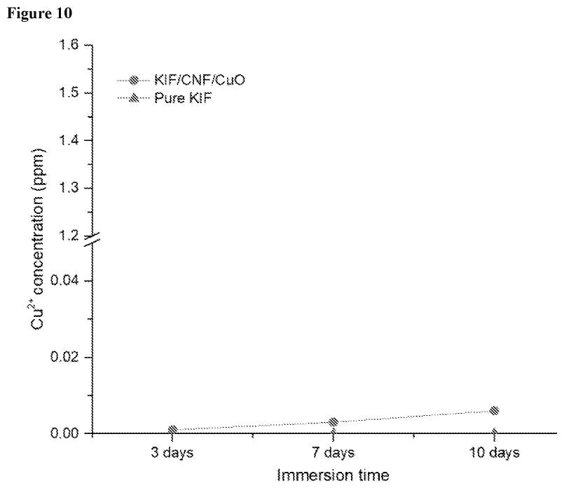

FIG. 10 shows the release profile of Cu ions into DI water for various keratin-based sponges including KIF, and KIF/CNF/CuO for 10 days CuO NPs blended within keratin matrix seemed not to dissolve into DI water. The content of ions released into DI water was assessed by Inductively Coupled Plasma Optical Emission Spectroscopy (ICP-OES). As shown, blended CuO NPs within keratin exhibited the negligible dissolution and were persistent in the aqueous environment. Ions released from the keratin-based sponge could influence seed germination, and seedling/roots/shoots development. Thus, developing a smart keratin-based sponge that could control ion release at different growth stage of the plants will be of great benefits to crop production using hydroponics culture systems. As ICP results showed, Cu ions had a sustained release into water for at least 10 days. This finding suggested that keratin-based sponges could be used to release metal ions under a control manner for enhancing plants growth.

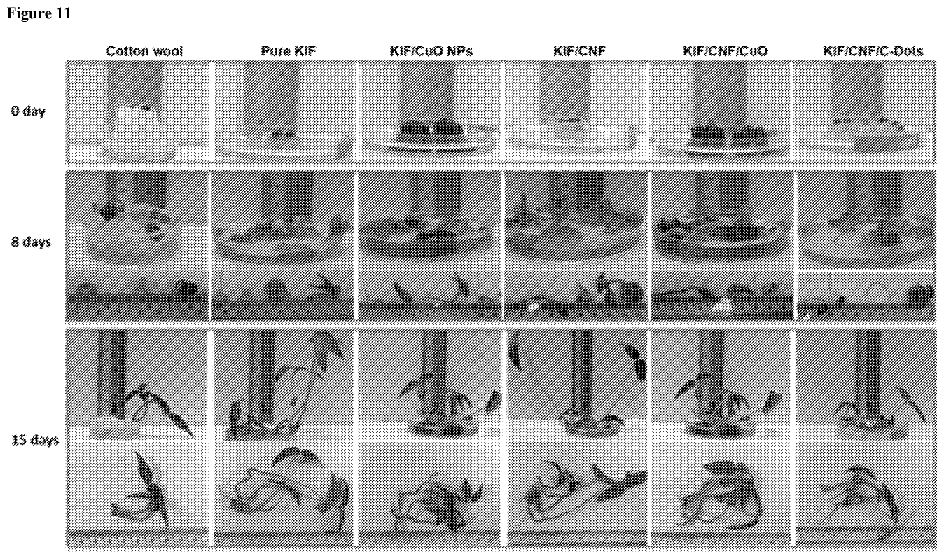

FIG. 11 shows the photographs of mung beans germinating and growing on different types of keratin-based sponges in 15 days. The preliminary results revealed that mung beans were able to germinate and grow on different keratin-based sponges such as KIF/CNF, KIF/NPs and KIF/CNF/NPs. Keratin-based sponges were able to support mung beans' germination, roots and shoots growth without causing any growth delay in comparison with cotton wools. Thus, keratin-based nanocomposites developed in the present invention have the potential of being used as support substrates for hydroponic plants growth in the near future. The digital photographs revealed that mung bean germination, roots and shoots length growth were improved in keratin-based sponges when compared with cotton wool, a common cellulose based substrate.

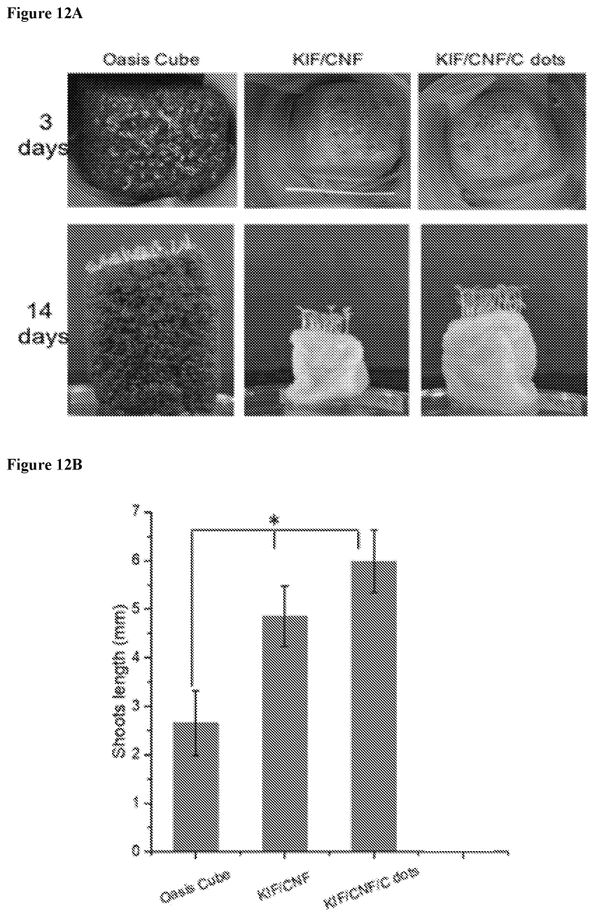

FIGS. 12A and 12B show the result of plant growth assessment on keratin-based substrates using Arabidopsis seeds over 14 days. Commercial Oasis Cubes were used as controls. KIF: Keratin intermediate filament proteins, CNF: Cellulose nanofibrils, C-dots: carbon-dots. The substrates contain 1.25 wt % of KIF, 0.5 wt % of CNF, 0.25 mg/ml C dots. To investigate whether the keratin-based substrates can enhance germination and development of seedlings, Arabidopsis seeds were sowed on keratin-based substrates as well as on Oasis Cube. The plant growth was photographed at day 3 and 14, respectively. As shown in FIG. 12A, the Arabidopsis seeds germinated with the development of complete seedlings within 3 days. In comparison with the Oasis Cube control, Arabidopsis seeds developed with greener leaves on keratin-based substrates. The Inventors further studied the influence of various substrates on seedling development over 14 days and measured the shoot length of the seedlings for all substrates. As shown in FIG. 12B, seedlings on KIF/CNF and KIF/CNF/C dots substrates displayed longer shoots (˜2 folds) compared with those on Oasis Cubes.

These results indicate that keratin-based substrates are beneficial for seed germination and growth.

### INDUSTRIAL APPLICABILITY

The disclosed substrate comprises keratin derivative and natural biopolymer. The disclosed substrate also further comprises nutrient. Further, the disclosed method to form the keratin-based substrate is easy to perform, simple, less laborious and can be utilized using solubilized keratin derivatives from any keratin source. The keratin-based substrate obtained from the disclosed method can be used for supporting seed germination and plant growth in a hydroponics culture environment.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A substrate comprising:
(a) keratin derivative; and
(b) natural biopolymer,
wherein the keratin derivative and natural biopolymer are crosslinked.

2. The substrate of claim 1, wherein the keratin derivative is selected from the group consisting of keratin intermediate filament protein, kerateine, keratose, and combinations thereof; or wherein the keratin derivative is derived from any human and/or animal source selected from the group consisting of hair, nail, wool, fur, horn, hoof, feather, scales, and combinations thereof.

3. (canceled)

4. The substrate of claim 1, wherein the natural biopolymer is a modified natural biopolymer; or wherein the natural biopolymer or modified natural biopolymer comprises hydroxyl, amine, carboxyl, thiol, aldehyde, and/or methacrylate groups; or wherein the natural biopolymer is selected from the group consisting of cellulose, modified cellulose, nanocellulose, modified nanocellulose, chitosan, modified chitosan, chitin, modified chitin, collagen, modified collagen, fibrinogen, modified fibrinogen, polysaccharide, modified polysaccharide, starch, modified starch, alginate, modified alginate, silk fibroin, modified silk fibroin, sericin, modified sericin, pullulan, modified pullulan, and combinations thereof.

5. (canceled)

6. (canceled)

7. The substrate of claim 4, wherein the nanocellulose is selected from the group consisting of cellulose nanocrystals, modified cellulose nanocrystals, cellulose nanofibrils, modified cellulose nanofibrils, bacterial nanocellulose, and modified bacterial nanocellulose.

8. The substrate of claim 1, wherein the molecular weight of the keratin derivative is about 40 kDa to about 60 kDa.

9. The substrate of claim 1, comprising about 0.5 wt % to about 2.0 wt % keratin derivative, based on the total weight of the substrate.

10. The substrate of claim 1, comprising about 0.25 wt % to about 1.0 wt % natural biopolymer, based on the total weight of the substrate.

11. The substrate of claim 1, wherein the weight percentage ratio of keratin derivative to natural biopolymer is about 5:1 to about 5:3.

12. The substrate of claim 1, wherein the substrate further comprises:
(c) micronutrients, macronutrients, pesticides and/or bioactives.

13. The substrate of claim 12, wherein the micronutrient is selected from the group consisting of metal oxides, metal salts, silica, carbon dots, and combinations thereof; or wherein the bioactive is selected from the group consisting of biomolecules, antimicrobial agents, omega 3, folic acid, boron and calcium.

14. (canceled)

15. The substrate of claim 13, wherein the metal is selected from the group consisting of zinc, copper, iron, magnesium, manganese, titanium, molybdenum, cobalt, nickel, silver, gold and combinations thereof.

16. The substrate of claim 12, wherein the micronutrients are particulates with an average diameter of about 1 nm to about 500 nm.

17. The substrate of claim 12, wherein the concentration of the micronutrient, pesticide or bioactive, when present, in the substrate is independently about 0.005 mg/ml to about 1.0 mg/ml, and the concentration of the macronutrient, when present, in the substrate is about 1 mg/ml to about 50 mg/ml.

18. The substrate of claim 1, wherein the substrate has a pore size of about 100 μm to about 200 μm.

19. The substrate of claim 1, wherein the substrate comprises:
(i) keratin intermediate filament protein;
(ii) cellulose nanofibrils; and
(iii) particulate micronutrients selected from the group consisting of metal oxides, metal salts, silica, carbon dots, and combinations thereof,
wherein the metal is selected from the group consisting of zinc, copper, iron, magnesium manganese, titanium, molybdenum, cobalt, nickel, silver, gold and combinations thereof.

20. A method of forming a substrate of claim 1, wherein the method comprises:
(i) mixing a solution of keratin derivative with a solution of natural biopolymer; and
(ii) drying the resulting solution of step (i) to obtain the substrate.

21. The method of claim 20, further comprising step (i′) dispersing micronutrients, macronutrients, pesticides, and/or bioactives, into the solution of keratin derivative, wherein step (i′) occurs before step (i).

22. The method of claim 20, wherein step (ii) comprises drying the resulting solution for at least 24 hours.

23. The method of claim 20, wherein step (ii) comprises freeze drying the solution of step (i) at a temperature of about −10° C. to about −80° C.

24. Use of a substrate of claim 1 as a plant growth medium or a hydroponic support medium.
